(19) United States
(12) Patent Application Publication
(10) Pub. No.: US 2004/0230640 A1
(43) Pub. Date: Nov. 18, 2004

(54) Method and system for processing a message in a mobile computer device

(76) Inventors: Michael K. Brown, Kitchener (CA); Herbert A. Little, Waterloo (CA)

Correspondence Address: David B. Cochran, Esq., JONES DAY, North Point, 901 Lakeside Avenue, Cleveland, OH, 44114, US

(21) Appl. No.: 10/772,476

(22) Filed: Feb. 5, 2004

(30) Foreign Application Priority Data
Feb. 7, 2003 (WO) PCT/CA03/00182

(51) Int. Cl. G06F 15/16

(52) U.S. Cl. 709/200

(57) ABSTRACT

A system and method for converting an initial message residing in a mobile computer device, which is capable of wireless access to a computer network, into a processed message. The system includes a menu option module that prompts a user of the mobile computer device to select a processing option for the initial message. When the user selects a translation option, the initial message is wirelessly sent to at least one server on the computer network for translation.

### CROSS REFERENCE TO RELATED APPLICATION

This application claims the benefit of International Application No. PCT/CA03/00182, filed on Feb. 7, 2003, the entire disclosure of which is incorporated herein by reference.

### FIELD OF THE INVENTION

This invention relates to mobile computer devices, and more specifically to the processing of messages displayed in such devices.

### BACKGROUND OF THE INVENTION

Mobile computer devices are widespread in present-day society, and include small, hand-held electronic devices such as personal data assistants (PDA's), personal information managers (PIM's), two-way pagers and the like. With the proliferation of such mobile computer devices, the demand for wireless access to computer networks using these devices has increased. For example, many hand-held electronic devices, such as the BlackBerry 6710 Wireless Handheld™ from Research in Motion, Inc., Waterloo, Ontario, are configured for wireless Internet access.

The portability of such electronic devices coupled with their ability to wirelessly access the global Internet has made international communication more extensive than ever. Along with the advantages inherent in such communication capabilities, problems have arisen associated with the exchange of information between disparate computer networks.

When a packet originating in a first network is sent to the mobile computer device via several other foreign networks, many problems can arise at the interfaces. Protocol and address conversions, and error, flow and congestion control are just some of the issues that must be addressed in the interface between different computer networks if communication is to occur. These interface issues occur at the computer level.

Paralleling these issues in mobile computer devices, which involve the exchange of information between different computer networks, is the exchange of information between humans who speak different languages. For example, an English speaking person carrying a mobile computer device may download a French Web page using wireless technology. Despite the impressive technology required to achieve such a download, if the English speaking person does not understand French, then communication breaks down at the human level.

### SUMMARY OF THE INVENTION

The present invention addresses the problem that arises when a user of a mobile computer device capable of wireless transmission receives text written in a foreign language. Program instructions in the mobile computer device allow the user to translate the foreign language text displayed by the device into a language that is understood by the user. The translation is achieved by transmitting the text to a server on a computer network that translates the text. The server then sends the translated text back to the mobile computer device.

More specifically, a system for translating text that is displayed in a first language in a mobile computer device capable of wireless access to a computer network is described herein. The system includes a translation menu option module in the mobile computer device. The module contains program instructions for presenting a menu option to a user of the device for translating the text. The system also includes a transmitter for wirelessly sending a representation of the text to at least one server on the computer network to translate the representation of the text into a second language. The system further includes a receiver in the mobile computer device for receiving a second representation of the translated text. The mobile computer device can then display the translated text.

Besides translation, other types of processing, such as encryption, can also be performed in a similar manner. In particular, a system is described herein for converting an initial message residing in the mobile computer device into a processed message. The system includes a menu option module in the mobile computer device. The menu option module includes program instructions for presenting a menu option to a user of the device for converting the initial message into the processed message. The system also includes a transmitter for wirelessly sending a representation of the initial message to at least one server on the computer network for converting the representation of the initial message into the processed message. The system further includes a receiver in the mobile computer device for receiving a representation of the processed message from a particular one of the at least one server.

Additionally, a computer-readable medium is described herein having recorded thereon a program for execution by a processor in a mobile computer device capable of wireless access to a computer network. The program serves to convert an initial message residing in the device into a processed message. In particular, the program includes instructions for presenting a menu option to a user of the device for converting the initial message into the processed message, and, after the user selects the menu option to convert, wirelessly sending a representation of the initial message to at least one server on the computer network for converting the representation of the initial message into the processed message. The program also includes instructions that allow the mobile computer device to receive a representation of the processed message from a particular one of the at least one server.

### BRIEF DESCRIPTION OF THE DRAWINGS

For a better understanding of the present invention and to show more clearly how it may be carried into effect, reference will now be made, by way of example, to the accompanying drawings, in which:

FIG. 1 shows a system for converting an initial message residing in a mobile computer device into a processed message, in accordance with the principles of the present invention;

FIG. 2 shows menu options provided by the menu option module of the system of FIG. 1;

FIG. 3 shows a system for translating text that is displayed in a first language in a mobile computer device, in accordance with the principles of the present invention;

FIG. 4 shows a pop-up having translation characteristic options, in accordance with the principles of the present invention; and

FIG. 5 shows a flow chart for converting an initial message residing in a mobile computer device into a processed message, in accordance with the principles of the present invention.

### DETAILED DESCRIPTION OF THE INVENTION

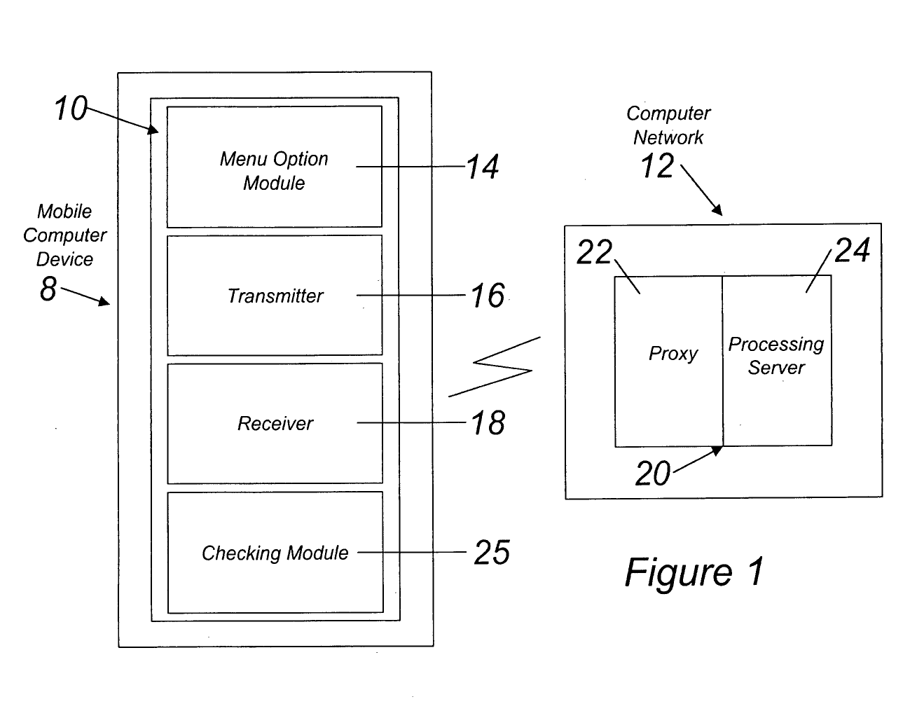

FIG. 1 shows a system 10 for converting an initial message residing in a mobile computer device 8, such as text displayed by the device 8, into a processed message. The mobile computer device 8 is capable of wireless access to a computer network 12. The system 10 includes a menu option module 14, a transmitter 16 and a receiver 18.

The menu option module 14 in the mobile computer device 8 includes hardware and software for presenting a menu option to a user of the device for converting the initial message into the processed message. In particular, the menu option module 14 includes program instructions for presenting the menu option to the user.

The transmitter 16 wirelessly sends a representation of the initial message to at least one server 20 on the computer network 12. The at least one server 20 converts the representation of the initial message into the processed message. The receiver 18 in the mobile computer device 8 receives the processed message, or a representation thereof, from the at least one server 20.

For example, the initial message can be text in a first language. The mobile computer device 8 can transform the text into a representation suitable for wireless transmission. For example, the text (initial message) can be converted into a digital signal (representation of the original message) for wireless transmission. The at least one server 20 can translate the representation of the text into one translated into a second language. The at least one server 20 includes all the software and hardware required to receive the representation of the text, and to convert it to translated text (processed message), or a representation of the translated text (such as a digital signal suitable for wireless transmission).

In one embodiment, the at least one server 20 includes a proxy 22 and a processing server 24, the representation of the original message being sent first to the proxy 22 and then to the processing server 24. The proxy 22 converts the representation of the message into a new format, such as hypertext markup language (HTML), before sending the reformatted representation of the message to the processing server 24 for further processing. The processing server 24 can be a translation server, such as Babelfish™, an encryption server, such as one that provides Pretty Good Privacy (PGP) encryption, and/or a spell check/thesaurus server, such as that found at http://dictionary.reference.com/ (an alias for www.websters.com).

Instead or in addition, the representation of the processed message can be received by the receiver 18 via the proxy 22 in the computer network 12. In such case, the proxy 22 converts the processed message from the processing server 24 into a device-formatted representation of the processed message before sending to the receiver 18.

The use of a proxy 22 frees up processor time in the mobile computer device 8 by outsourcing to the proxy 22 tasks such as converting to HTML before sending to the processing server 24, and/or converting to mobile computer device format prior to sending to the receiver 18.

The initial message can be text displayed on the mobile computer device 8 in a first language. The text can form part of an email or a Web page. The system 10 can include a checking module 25 for automatically checking to determine whether the initial message corresponds to text in a language that is not native to a user of the mobile computer device. If the checking module 25 determines that the text is in a non-native language, the checking module 25 can automatically prompt the user to determine if the user wishes the text to be translated.

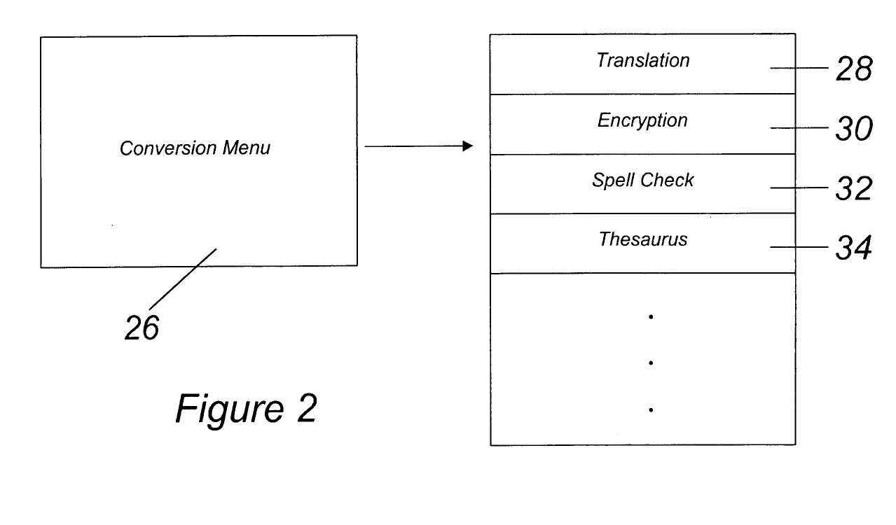

FIG. 2 shows menu options provided by the menu option module 14. When the user selects the conversion menu 26, several menu options are displayed to the user. The menu option can include a translation option 28, an encryption option 30, a spell check option 32 or a thesaurus option 34. Selecting the translation option 28 can cause a pop-up (not shown in FIG. 2) to be displayed. The pop-up prompts a user of the mobile computer device 8 to choose at least one translation characteristic option, as described in more detail below.

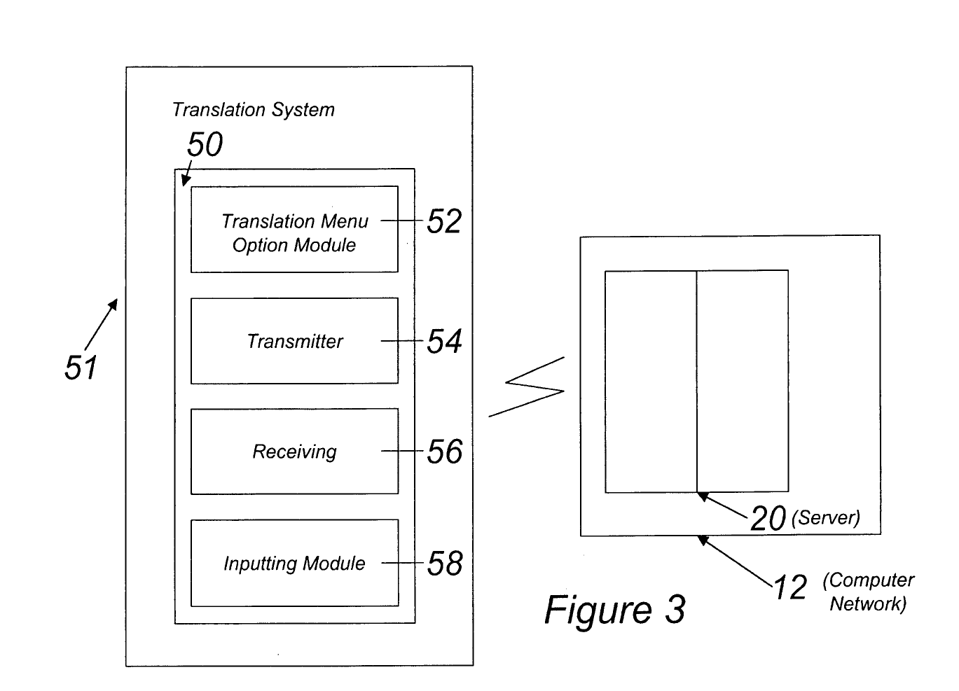

FIG. 3 shows a translation system 50 for translating text that is displayed in a first language in a mobile computer device 51 consistent with the principles of the present invention. The mobile computer device 51 is capable of wireless access to a computer network 12, such as the Internet. The system 50 includes a translation menu option module 52, a transmitter 54 and a receiver 56.

The translation menu option module 52 has program instructions for presenting a menu option to a user of the device for translating the text. The transmitter 54 wirelessly sends a representation of the text to at least one server 20 on the computer network 12 to translate the representation of the text into a second language. A receiver 56 receives a second representation of the translated text.

The user can highlight the text to be translated. An inputting module 58 allows the user to issue a command to translate the highlighted text. For example, the inputting module 58 can include the thumb-operated trackwheel found in the aforementioned BlackBerry 6710 Wireless Handheld™. The trackwheel allows the user to highlight text and issue commands for translating. The translation menu option module 52 can input the request to translate and output a pop-up having one or more translation characteristic options.

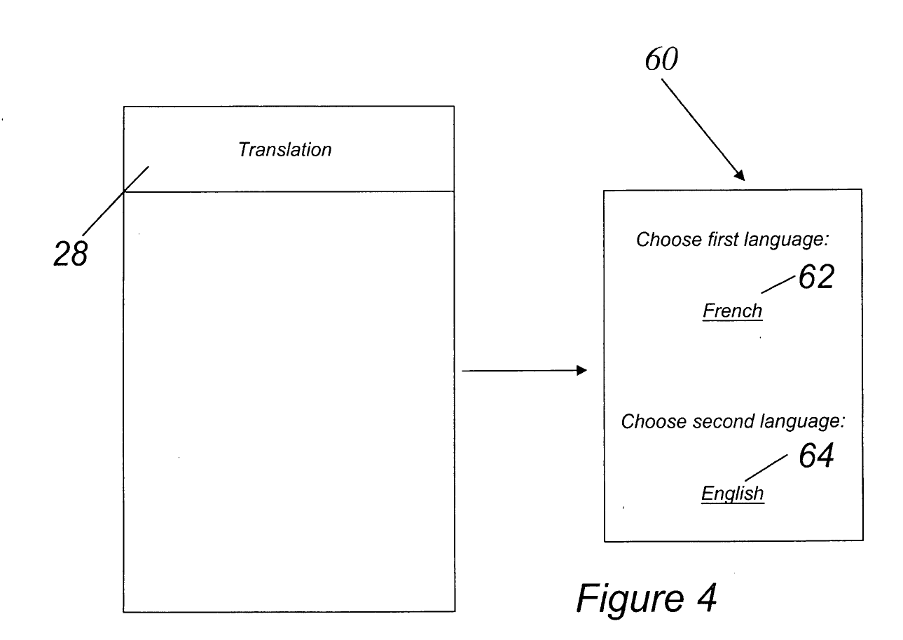

FIG. 4 shows a pop-up 60 having translation characteristic options. The pop-up 60 can be displayed to the user after the user chooses the translation option 28 in the conversion menu 26. The translation characteristic options can include a first language option 62 to choose the first language in which the original textual message is written, and a second language option 64 to choose the second language into which the textual processed message is to be displayed on the mobile computer device 8. The highlighted text can be part of an email or Web page.

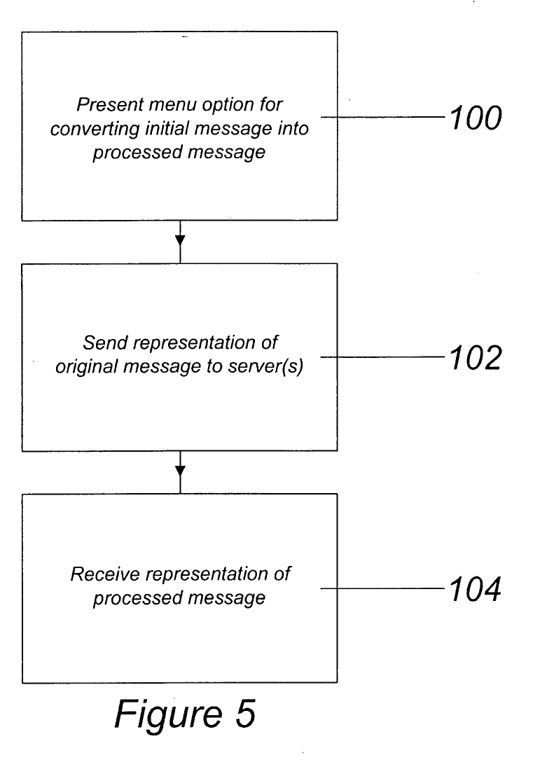

FIG. 5 shows a flowchart for converting an initial message residing in a mobile computer device capable of wireless access to a computer network into a processed message. In step 100, a menu option is presented to a user of the device for converting the initial message into the processed message. Program instructions for presenting the menu option originate in the mobile computer device. After the user selects the menu option to convert, in step 102, a representation of the initial message is wirelessly sent to at least one server on the computer network for converting the representation of the initial message into the processed message. In step 104, the mobile computer device receives a representation of the processed message from a particular one of the at least one server.

It should be understood that various modifications could be made to the embodiments described and illustrated herein, without departing from the present invention, the scope of which is defined in the appended claims. Although emphasis has been placed on translating text from one language to another, other forms of data processing fall within the scope of the invention. For example, mention has been made of encryption, spell check and thesaurus processing. Other examples include sorting, grammar checking, and format conversion. The initial messages processed can include data files of various sorts and need not be only files associated with text.

What is claimed is:

1. A method of converting an initial message residing in a mobile computer device capable of wireless access to a computer network into a processed message, the method comprising:
presenting a menu option to a user of the device for converting the initial message into the processed message, wherein program instructions for presenting the menu option originate in the mobile computer device;
after the user selects the menu option to convert, wirelessly sending a representation of the initial message to at least one server on the computer network for converting the representation of the initial message into the processed message; and
the mobile computer device receiving a representation of the processed message from a particular one of the at least one server.

2. The method of claim 1, wherein, in the step of wirelessly sending, the at least one server includes a proxy and a processing server, the representation of the original message being sent first to the proxy and then to the processing server.

3. The method of claim 2, wherein the proxy converts the representation of the message into a new format before sending the reformatted representation of the message to the processing server.

4. The method of claim 3, wherein the new format is hypertext markup language (HTML).

5. The method of claim 1, wherein, in the step of receiving, the representation of the processed message is received by the mobile computer device via a proxy in the computer network.

6. The method of claim 5, wherein the proxy converts the processed message into a device-formatted representation of the processed message before sending to the mobile computer device.

7. The method of claim 1, wherein the menu option is a translation option, an encryption option, a spell check option or a thesaurus option.

8. The method of claim 1, wherein the initial message is text displayed on the mobile computer device in a first language.

9. The method of claim 8, wherein the text forms part of an email.

10. The method of claim 8, wherein the text is in a Web page.

11. The method of claim 8, wherein the menu option is a translation option, such that when the translation option is selected, a pop-up is displayed prompting a user of the mobile computer device to choose at least one translation characteristic option.

12. The method of claim 11, wherein the pop-up prompts the user to identify the first language.

13. The method of claim 11, wherein the pop-up prompts the user to choose a second language into which the text is to be translated.

14. The method of claim 1, further comprising, before the step of presenting, automatically checking to determine whether the initial message corresponds to text in a language that is not native to a user of the mobile computer device.

15. A method for translating text displayed in a mobile computer device capable of wireless access to a computer network, the method comprising:
receiving the text in a first language;
presenting a menu option to a user of the device for translating the text, wherein program instructions for presenting the menu option originate in the mobile computer device;
wirelessly sending a representation of the text to at least one server on the computer network to translate the representation of the text into a second language; and
receiving a second representation of the translated text.

16. The method of claim 15, wherein, in the step of receiving the text in a first language, the text is received in an email.

17. The method of claim 15, wherein, in the step of receiving the text in a first language, the text is received in a Web page.

18. The method of claim 15, further comprising, before the step of wirelessly sending, inputting a command into the mobile computer device indicating a request to have the text translated.

19. The method of claim 15, further comprising, before the step of presenting, selecting a menu having a translation menu option.

20. The method of claim 19 where, upon selecting the translation menu option, a pop-up is displayed prompting a user of the mobile computer device to choose at least one translation characteristic menu option.

21. The method of claim 20, wherein the pop-up prompts the user to identify the first language.

22. The method of claim 20, wherein the pop-up prompts the user to choose the second language.

23. A system for converting an initial message residing in a mobile computer device capable of wireless access to a computer network into a processed message, the system comprising:
a menu option module in the mobile computer device that includes program instructions for presenting a menu option to a user of the device for converting the initial message into the processed message;
a transmitter for wirelessly sending a representation of the initial message to at least one server on the computer network for converting the representation of the initial message into the processed message; and
a receiver in the mobile computer device for receiving a representation of the processed message from a particular one of the at least one server.

24. The system of claim 23, wherein, the at least one server includes a proxy and a processing server, the representation of the original message being first sent to the proxy and then to the processing server.

25. The system of claim 24, wherein the proxy converts the representation of the message into a new format before sending the reformatted representation of the message to the processing server.

26. The system of claim 25, wherein the new format is hypertext markup language (HTML).

27. The system of claim 23, wherein the representation of the processed message is received by the receiver via a proxy in the computer network.

28. The system of claim 27, wherein the proxy converts the processed message from the server into a device-formatted representation of the processed message before sending to the receiver.

29. The system of claim 23 wherein the menu option is a translation option, an encryption option, a spell check option or a thesaurus option.

30. The system of claim 23, wherein the initial message is text displayed on the mobile computer device in a first language.

31. The system of claim 30, wherein the text forms part of an email.

32. The system of claim 30, wherein the text is in a Web page.

33. The system of claim 30, wherein the menu option is a translation option, such that when the translation option is selected, a pop-up is displayed prompting a user of the mobile computer device to choose at least one translation characteristic option.

34. The system of claim 33, wherein the pop-up prompts the user to identify the first language.

35. The system of claim 33, wherein the pop-up prompts the user to choose a second language into which the text is to be translated.

36. The system of claim 23, further comprising a checking module for automatically checking to determine whether the initial message corresponds to text in a language that is not native to a user of the mobile computer device.

37. A system for translating text that is displayed in a first language in a mobile computer device capable of wireless access to a computer network, the system comprising:
a translation menu option module in the mobile computer device having program instructions for presenting a menu option to a user of the device for translating the text;
a transmitter for wirelessly sending a representation of the text to at least one server on the computer network to translate the representation of the text into a second language; and
a receiver in the mobile computer device for receiving a second representation of the translated text.

38. The system of claim 37, wherein the text is part of an email.

39. The system of claim 37, wherein the text is part of a Web page.

40. The system of claim 37, further comprising, an inputting module for inputting a command into the mobile computer device indicating a request to have the text translated.

41. The system of claim 37, wherein, before the translation menu option module presents the menu option, a user of the mobile computer device selects a menu having a translation menu option.

42. The system of claim 41 where, when the user selects the translation menu option, a pop-up is displayed prompting a user of the mobile computer device to choose at least one translation characteristic menu option.

43. The system of claim 42, wherein the pop-up prompts the user to identify the first language.

44. The system of claim 42, wherein the pop-up prompts the user to choose the second language.

45. A computer-readable medium having recorded thereon a program for execution by a processor in a mobile computer device capable of wireless access to a computer network for converting an initial message residing in the device into a processed message, the program comprising instructions for
presenting a menu option to a user of the device for converting the initial message into the processed message;
after the user selects the menu option to convert, wirelessly sending a representation of the initial message to at least one server on the computer network for converting the representation of the initial message into the processed message; and
the mobile computer device receiving a representation of the processed message from a particular one of the at least one server.

46. The computer-readable medium of claim 45, wherein the initial message is in a first language, and the processed message is in a translated language.
